(19) United States
(12) Patent Application Publication
(10) Pub. No.: US 2013/0171302 A1
(43) Pub. Date: Jul. 4, 2013

(54) SYSTEM AND METHOD FOR USING VEGETABLE OIL WITH MODIFIED RHEOLOGY AS POPCORN FAT

(71) Applicants: Troy Bierbaum, Minneapolis, MN (US); Jennifer Folstad, Centerville, MN (US); Dharma Kodali, Plymouth, MN (US); Philip K. Zietlow, Wayzata, MN (US)

(72) Inventors: Troy Bierbaum, Minneapolis, MN (US); Jennifer Folstad, Centerville, MN (US); Dharma Kodali, Plymouth, MN (US); Philip K. Zietlow, Wayzata, MN (US)

(21) Appl. No.: 13/691,824

(22) Filed: Dec. 2, 2012

Related U.S. Application Data
(63) Continuation of application No. 13/500,816.
(60) Provisional application No. 61/249,556, filed on Oct. 7, 2009.
(60) Provisional application No. 61/249,552, filed on Oct. 7, 2009.

(51) Int. Cl. A23D 9/007

(52) U.S. Cl. CPC A23D 9/007
USPC 426/111; 426/601

(57) ABSTRACT

Disclosed is a trans fat replacement system and a composition comprising a composition of an expanded, low-density carbohydrate and at least one edible oil wherein the expanded, low-density carbohydrate modifies the rheology of the at least one edible oil.

### RELATED APPLICATIONS

This application claims the benefit of U.S. provisional application 61/249,556 and 61/249,552, both filed on Oct. 7, 2009, which are hereby incorporated herein in their entirety for all purposes.

### FIELD

The invention relates to reduction of saturated fat and trans fats in popcorn products. More specifically, the invention relates to a mixture of an expanded, low density carbohydrate and at least one saturated, edible oil that forms a trans fat replacement system.

### BACKGROUND

Trans fatty acids are unsaturated fatty acids in which the hydrogen atoms of a double-bond, or unsaturation, are located on opposite sides of the molecule and are therefore in the “trans” conformation. The trans isomer of the fatty acid causes the carbon chain to assume a straight-chain configuration similar to that of a saturated fat. Trans fatty acids are primarily formed through the metal-catalyzed process of hydrogenation, however they have also been found to form naturally at low levels in cow's milk. By hydrogenating oils through industrial processing, hydrogen atoms are added to unsaturated sites on fatty acids, creating a larger population of saturated fats in the oil. In a partially hydrogenated oil, some of the unsaturated fatty acids remain. However, the processing causes some of the double-bonds of the unsaturated fatty acids to undergo isomerization to the trans configuration. A number of research studies have provided evidence that the consumption of foods having saturated fats and trans fats adversely effects cholesterol levels and can lead to an increased potential for cardiovascular diseases. One method by which the trans fat levels can be reduced is to replace the use of solid saturated fats such as shortening or butter with edible oils that typically contain unsaturated fats. Suitable edible oils can include the vegetable oils such as corn, sunflower, canola and the like, the marine oils or other similar unsaturated oils. While these edible oils allow for the replacement of trans fats, the liquid nature of these edible oils can create inconvenience and difficulty in preparing popcorn products when compared to traditional solid fats. For example, the viscous nature of liquid, edible oils makes it difficult to provide a popcorn charge in a popping bag that will not flow in typical storage conditions. In addition, edible oils are subject to oxidation, which reduces the shelf life of edible oils as compared to traditional solid fats.

A trans fat replacement system for baked goods has been disclosed in U.S. patent application Ser. No. 10/934,098, Publication US 2005-0123668 A1 (also published as WO 2006/029080) and related U.S. Pat. No. 6,787,170. The latter addresses a manner of imparting a fried texture on baked goods through use of a glaze mixture of an edible oil and a maltodextrin. The former addresses use of an edible oil and an expanded, low density carbohydrate to help retain the position of oil during rolling and sheeting of laminated dough products. However, the issues with using such compositions with dough-based baked goods are not the same as the issues that must be addressed for a commercially viable popcorn product. For instance, primary concerns with microwave popcorn food products include shelf stability, scorching, flavoring and residue distribution, and heat transfer characteristics favorable to popping.

As such, it would be advantageous to develop a trans fat replacement system for use in popcorn products that overcomes the problems presently associated with the use of saturated, edible oils.

### SUMMARY

A trans fat replacement system of the invention provides a composition allowing for the reduction or elimination of trans fats in popcorn products. The trans fat replacement system can comprise a composition of an expanded, low-density carbohydrate and at least one edible oil. In another embodiment the trans fat replacement system comprises a composition of ground popped pop corn and at least one edible oil. In a preferred embodiment, the trans fat replacement system has a paste-like consistency.

All percentages are by weight (wt %) unless otherwise indicated. Further embodiments of the invention, without limitation, will become apparent from the following figures, detailed description, and examples.

### BRIEF DESCRIPTION OF THE DRAWINGS

FIG. 1 is a perspective view of an unsealed partially folded microwave popcorn bag ready for filling.

### DETAILED DESCRIPTION

In an embodiment of the invention, a trans fat replacement system comprises a composition of an expanded, low-density carbohydrate and at least one edible oil.

The expanded, low-density carbohydrate generally comprises a long chain carbohydrate defining a random, porous structure. The long chain, random porous structure of the expanded, low-density carbohydrate results in a bulk density of less than about 0.5 g/cc. Examples of suitable expanded, low-density carbohydrates can comprise expanded dextrins, starches, celluloses, gums and other suitable carbohydrates having random porous structures with bulk densities less than about 0.5 g/cc.

In an embodiment of the invention, the expanded low-density carbohydrate comprises maltodextrin having a bulk density of about 0.05 to about 0.4 g/cc, and in particular, having a bulk density of about 0.10 to about 0.15 g/cc. Examples of suitable maltodextrins include MALTRIN® (available from Grain Processing Corporation of Muscatine, Iowa), N-ZORBIT® M (available from National Starch and Chemical of Bridgewater, N.J.), and STAR-DRI® (available from Tate & Lyle of London, United Kingdom).

Alternatively, the expanded low-density carbohydrate can comprise a carbohydrate gum having a bulk density of about 0.05 to about 0.4 g/cc. A suitable carbohydrate gum includes PURITY® Gum (available from National Starch and Chemical).

The edible oil can comprise anyone of a variety of saturated edible oils. Examples of such oils can include animal oils, dairy oils such as butter oil, marine oils such as fish oil, tree nut oils, fruit oils such as coconut oil, and vegetable oils such as soybean oil, corn oil, rapeseed or canola oil, copra oil, cottonseed oil, safflower oil, olive oil, sunflower oil, peanut oil, palm oil, palm kernel oil, and rice bran oil. The edible oil can comprise a single saturated edible oil or can comprise a mixture of a plurality of said saturated edible oils. The trans fat replacement system can be formed in a number of ways. In general, mixing the edible oil with the expanded, low-density carbohydrate forms the trans fat replacement system. The expanded, low-density carbohydrate physically entraps the edible oil molecules, preventing the oil from flowing as readily. This minimizes oil flow and migration during the charging of a popcorn slurry into a popping bag, as well as during storage and preparation of the popcorn food product.

In some embodiments, the expanded, low-density carbohydrate may undergo a pre-treatment step whereby the oil entrainment capacity of the expanded, low density carbohydrate is enhanced. In one embodiment, the expanded, low-density carbohydrate can by dried by heating the expanded, low-density carbohydrate to drive off moisture. In order to prevent charring, the expanded, low-density carbohydrate can be mixed with the edible oil before heating the expanded, low density carbohydrate. For example, the expanded, low-density carbohydrate can be dried at a temperature of about 100° C. under vacuum. In some instances, the expanded low-density carbohydrate may have entrained air pockets that are typically removed by vacuum prior to applying heat. One representative example of a dried expanded, low density carbohydrate is N-ZORBIT® which is available with a moisture content of 7.6% and an oil entrainment capability of 5 to 6 times its own weight. Upon drying to a moisture content of less than 1%, N-ZORBIT® has an oil entrainment capability of 9 times its own weight.

In another alternative embodiment, a suitable emulsifier can be added to increase the oil entrainment capability of the expanded, low-density carbohydrate. For instance, the addition of 1% by weight of distilled monoglyceride to NZORBIT® causes the oil entrainment ability of N-ZORBIT® to increase from 5 to 6 times its own weight up to 8 times its own weight. The trans fat replacement system for popcorn is now illustrated in greater detail by way of the following example.

In an embodiment, the trans fat replacement system can be used to reduce the amount of trans fat present in a popcorn product. For instance, the trans fat replacement system can be used to make popcorn products labeled as having a reduced trans fat content. A trans fat replacement system used in preparing popcorn products having a reduced trans fat content can make use of traditional solid fats, for example butter, albeit in lesser amounts than used in preparing current popcorn products.

A formulation for reducing the amount of trans fats present in a popcorn product is shown in Table 1.

TABLE 1
Popcorn Fat Slurry for Reduced Trans Fat Content

| | Amount |
|---|---|
| Fat Replacement Formulation | (grams) |
| Rheology-modified vegetable oil | 148.18 |
| Salt | 11.31 |
| Butter | 8.26 |
| Flavoring/Coloring | 2.25 |

In this particular example, the Rheology-modified vegetable oil is prepared by mixing one part RBD soybean oil with eight parts N-Zorbit M maltodextrin at room temperature to form into a solid paste. In one embodiment, the maltodextrin is dried; in another embodiment it is undried.

The formulation of the fat slurry including individual amounts of soybean oil and maltodextrin is show in Table 2.

TABLE 2
Popcorn Fat Slurry for Reduced Fat Content with
Additional Detail

| Ingredient | Amount (g) | % |
|---|---|---|
| RBD soybean oil | 16.46 | 9.7% |
| N-Zorbit M maltodextrin | 131.72 | 77.5% |
| salt | 11.31 | 6.7% |
| butter | 8.26 | 4.9% |
| flavoring/coloring | 2.25 | 1.3% |

In this example, a 37.1 gram charge of slurry is combined with 68.5 grams of corn for placement into a microwave popping bag. Table 3 shows the ingredients for an example bag of popcorn.

TABLE 3
Example Microwave Popcorn Article

| Ingredient | Amount (g) | % |
|---|---|---|
| Popcorn | 68.50 | 64.6% |
| RBD soybean oil | 3.63 | 3.4% |
| N-Zorbit M maltodextrin | 29.05 | 27.4% |
| salt | 2.49 | 2.4% |
| butter | 1.82 | 1.7% |
| flavoring/coloring | 0.50 | 0.5% |

Variations in flavor intensity are obtained by managing residue on the popcorn through use of dried maltodextrin (less residue) rather than undried maltodextrin, and by varying how the slurry and corn are combined. For instance, mixing the corn with the fat slurry as opposed to layering one on top of another are found in practice to vary residue on the corn during popping and, accordingly, flavor.

The edible oil is added to the expanded, low-density carbohydrate and mixed at a reduced rate so as to not alter the random, porous structure of the expanded, low-density carbohydrate. As the mixing proceeds, the edible oil is entrapped within the random, porous structure of the expanded, low-density carbohydrate.

Depending upon the characteristics of the selected expanded, low-density carbohydrate and the proportions of edible oil to expanded, low-density carbohydrate, the trans fat replacement system can have a consistency ranging from a powder to a paste. The trans fat replacement system preferably has a paste-like consistency when used for popcorn.

In one embodiment, popcorn itself is used as the carbohydrate thickener for the oil. Specifically, popped popcorn is ground and mixed with an oil to achieve a thickened consistency usable as a popping fat in a popcorn product. The consistency is sufficiently solid at room temperature that the composition can be used to charge microwave popcorn bags and other home-popping containers for which transportation and storage at room temperature would make unmodified oils unsuitable. In a preferred embodiment, palm oil is prepared by adding dried, ground, popped popcorn to the oil at a 1-3% level. The resulting composition is found to be very solid at room temperature.

In comparing popcorn prepared as described above with the traditionally prepared popcorn, total fat per serving is modestly reduced, saturated fat per serving is dramatically reduced, and trans fat is eliminated.

The trans fat replacement system can be used with a conventional microwave popcorn popping container. Useful microwave containers herein can include any container for microwave popcorn products presently known in the art or are developed in the future. Cardboard tubs have also been recently developed for microwave popcorn articles and can be used as the microwave container. Particularly useful herein for the microwave popping container are a wide variety of commercially available microwave bags for microwave popcorn.

For example, a suitable bag widely used commercially and preferred for use herein is described in U.S. Pat. No. 4,450,180. A generally similar bag is described in U.S. Pat. No. 4,548,826 or in U.S. Pat. No. 4,973,810 Microwave method of popping popcorn and package therefor” issued Nov. 27, 1990 to Arne Brauner. Also useful are structures described in U.S. Pat. No. 4,735,513 and U.S. Pat. No. 4,878,765. Generally, the bag therein described comprises and is fabricated from a flexible sheet material having two collateral tubular sections. The sections are parallel longitudinally extending that communicate with each other at the center of the package.

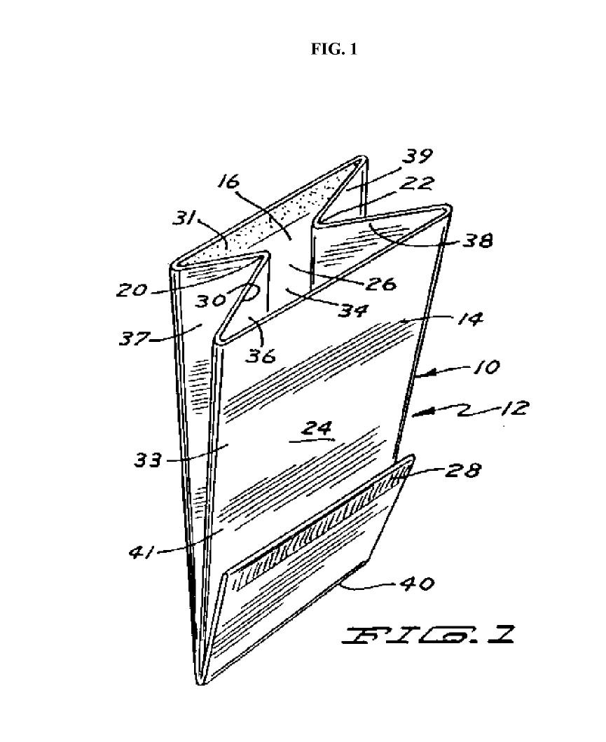

In one embodiment, the trans fat replacement system can be used with popcorn products provided in a popping bag such as the one illustrated in FIG. 1. In FIG. 1, there is shown an embodiment of a microwave popcorn article 10 composed of a microwave bag 12 formed from flexible sheet material such as paper and being of collateral tubular configuration, that is to say, being composed of a pair of parallel longitudinally extending tubes 14 and 16 which communicate with one another along a central longitudinal opening. The two parallel tubes 14 and 16 are separated by longitudinally extending side indentations 20 and 22. When the package comprises a paper bag, the bag can be composed of first and second face panels 24 and 26 respectively and the indentations 20 and 22 comprises gussets. When in a vertically aligned orientation, the bag has a bottom seal 28 and initially an open top or orifice 30 but a sealable seal area 31 that transversely extends the open sealable top. The sealable area can include a heat activated adhesive or a “cold seal” adhesive, as is convenient. After being filled, the top 30 is also sealed conventionally by means of heat or other suitable adhesive to provide a top seal in the top seal area 31.

The bag material is generally fabricated with multiple plies including an outer ply 33 which is generally paper, a grease-proof or resistant inner ply 34 and microwave susceptor film member or ply intermediate these inner and outer paper layers. However, in preferred embodiments the microwave susceptor is present only on one major face panel. The microwave susceptor provides supplemental heating for heating the food charge to cause popping of the popcorn.

While tubes (or chambers, or channels) 14 and 16 can be of equal size, conventionally the susceptor channel 16 is generally slightly smaller. In such a configuration, the gussets include major left gusset face 36, minor left gusset face 37, major right gusset face 38 and minor right gusset face 39. The bag 12 can be provided with a lower transverse fold 40 to define an intermediate portion or pocket 41.

Although in the present description, a particular description is given to this preferred microwave bag, the present improvement is also useful in connection with, for example, flat bottomed bags, bags with or without a bottom fold, with a straight bottom seal or other more complex bottom seal designs. Also, the present methods can be employed using new and improved microwave popcorn popping bag designs.

Since introduction, microwave popcorn bags have undergone continued development generally directed towards cost reduction especially of the expensive microwave susceptor component. Also, improvements continue to be made (see for example U.S. Ser. No. 09/943,637 “EASILY EXPANDABLE, NONTRAPPING, FLEXIBLE PAPER, MICROWAVE PACKAGE” filed Aug. 31, 2001 by Monforton) to improve popping performance or to facilitate commercial manufacturing at lower cost or at higher packaging line speeds.

While particular attention is given to microwave bags herein as the preferred microwave container, the skilled artisan will appreciate that the present trans fat replacement system is broadly useful when used with a variety of packaging and disposable microwave containers.

### Method of Preparation

Broadly, the present methods of preparation include the steps of adding the food charge to an at least partially open microwave popping container to form a filled container and sealing the filled container to provide a finished sweet coating microwave popcorn article product.

In one variation, the food charge is formed in a single composite mass such as a toroid or ring and the composite mass charged to an open microwave popcorn bag or other container prior to final sealing. (See for example U.S. Pat. No. 4,450,180, issued May 22, 1984).

In another variation one or more ingredients are added separately to the open microwave bag. For example, microwave bags having an unsealed open end and a folded lower portion are advanced to a first kernel popcorn filling station. While being maintained in an open position, the loose kernel popcorn is charged to the desired channel in desired amounts to form partially filled bags containing kernel popcorn. The kernel popcorn is added first to facilitate more even distribution of the balance of ingredients over the popcorn to thereby provide a finished popcorn having a more even distribution of the coating ingredients. In those variation that include puffable pellets other than or in admixture with kernel popcorn, the puffable pellets or popcorn- and-pellet mixtures are likewise first added to the microwave popcorn bag.

Thereafter, the partially filled bags are advanced to a second filling station at which a slurry is added to the bag. Typically, the slurry is added in the form of a vertically dispensed pencil jet (i.e., a confined stream) of the slurry. (See, for example, U.S. Pat. No. 4,604,854 entitled “Machine For Forming, Filling and Sealing Bags,” issued Aug. 12, 1986 to D. W. Andreas). The slurry contains the at least one edible oil, the expanded, low density carbohydrate and optionally includes flavors, colors, etc. For those embodiments comprising salt in flour form, the slurry can include all or a portion of the flour salt. At the same station, a separate quantity of optional particulate or dry ingredients, e.g., salt in coarse form and/or calcium, isomalt, flavors, colors, can be added to the open partially filled microwave popcorn bag (See, for example, FIG. 1 line 70). If added, the slurry addition and particulate or dry ingredient addition can be practiced sequentially (in either order) or simultaneously. Simultaneous addition or parallel addition is preferred since this technique allows for high packaging line processing speeds thereby increasing efficiency compared to sequential addition in a two station filling method.

Single station filling methods are also known that involve applying the fat/salt slurry as a spray onto the kernel popcorn as the kernel popcorn falls into the bag. (See, for example WO 95/01105 entitled “Reduced Fat Microwave Popcorn and Method of Preparation” published Jan. 12, 1995, or, equivalently, U.S. Pat. No. 5,690,979 issued Nov. 25, 1997; or U.S. Pat. No. 5,171,950 “Flexible Pouch and Paper Bag Combination For Use In The Microwave Popping of Popcorn” issued Dec. 5, 1992 to Brauner et al.) which is incorporated herein by reference. Such single station filling techniques are especially useful for the preparation of low fat microwave popcorn products. In this variation, any optional particulate or dry ingredients in powder form can be added to the popcorn filling funnel along with the popcorn, e.g., after the popcorn has been charged to the bag.

The bags now containing both kernel popcorn and slurry and other ingredients are then advanced to a sealing station where the bags are provided with a top seal to complete the closure of the bag. The sealed popcorn bags are advanced to subsequent finish packaging operations that complete the folding of the bags, providing the bags with an overwrap, and inserting appropriate numbers of the bags into cartons, etc.

The term slurry is used herein as is common in the microwave popcorn art to refer to any coating applied to the kernel popcorn. The term “slurry” as used generally herein thus includes fat alone; fat and a lesser portion of salt in flour form; fat, flour salt, flavors and/or color or sweetener(s); fat, a portion of the flour salt and a portion of the calcium ingredient; and fat and substantially all of the calcium ingredient as well as any other variation or combination of ingredients used as an addition to the kernel popcorn herein.

The slurry can additionally optionally comprise minor amounts of other materials employed to make the microwave popcorn more aesthetically or nutritionally or organoleptically appealing. Such adjuvant ingredients can include, for example, limited amounts of sugar(s), micro fortification levels of minerals, vitamins, colorants, preservatives and flavors. If present, each of these constituents can comprise from about 0.01 to about 2% by weight of the fat slurry.

Especially popular for use herein is a butter flavor. The flavors can be either in liquid, fat soluble forms and/or in dry powder forms such as a liquid oil absorbed onto a particulate carrier, e.g., gum arabic, starch, silicon dioxide, or dehydrated cheese solids or in the form of an oil suspension.

The fat slurry is prepared simply by admixing the expanded, low-density carbohydrate and at least one edible oil together with any optional ingredients with salt and blending the mixture to form a stable dispersion or slurry. The fat or slurry, while still fluid (70° to 130° F.; 21° to 55° C.), is then sprayed into the microwave popcorn bag as described in detail below.

The slurry application step can be practiced by employing an applicator for spraying the fat slurry (e.g., commercially available from Hibar Systems Limited, Ontario, Canada) that is supplied by a slurry supply means. The slurry supply means can conveniently include a conventional positive displacement reciprocating metering pump having a piston and a pressurized slurry inlet. The pump precisely pumps metered amounts of the fat slurry to the applicator at closely controllable time intervals.

If the slurry viscosity is too high, the slurry becomes unpumpable. The concentrations of salt and calcium ingredients are selected such that the slurry has a viscosity of less than 10,000 cps, preferably less than about 1,000 cps, and, for best results, less than 300 cps.

The slurry can be added at temperatures ranging from about 15.5° to 65.5° C. (60° to 150° F.), preferably about 38° to 54.4° C. (100° to 130° F.).

While a pencil jet spray is preferred for use herein, equivalents thereof in terms of dispensing the slurry can also be used. For example, a multiplicity of very fine jet streams, (e.g., 3-12), or a sparge can be used to achieve the desired dispersion hereunder. Also, other spray types, (e.g., a cone spray, a mist spray, or a fan spray) are useful herein. However, great care must be taken in selecting such useful alternatives so as to avoid getting slurry in the bag seal area. In other embodiments, the spray can be gas assisted, e.g., air, steam, or inert gas.

In preferred embodiments, the bag 12 has a microwave chamber (i.e., wherein one major face panel has an intermediate microwave susceptor layer between the inner and outer bag layers) and, for cost considerations, a microwave susceptor-free chamber. In the preferred practice, the kernel popcorn, fat slurry and particulate(s) are charged to the microwave channel. Conventionally, the microwave channel is the lesser channel (i.e., being formed by the smaller major face 24) and the greater channel is the microwave free channel. Such a configuration minimizes the amount of relatively expensive microwave susceptor material required while nonetheless providing the needed expansion volume upon microwave popping.

In the preferred form, the popcorn charging and slurry addition are practiced at separate stations and as separate steps. However, in other embodiments, the kernel popcorn and slurry addition can be practiced in a single station concurrently. Apparatus and techniques for such concurrent filling of the popcorn and slurry are described in commonly assigned U.S. Pat. No. 5,690,979 (issued Nov. 25, 1997) entitled “Method Of Preparing Reduced Fat Microwave Popcorn.”

If high levels of salt and calcium ingredients are desired in the finished products, addition of the total quantity of each of these materials to the slurry will cause the slurry viscosity to be excessively high. That is, while the slurry may be able to carry all of the salt or all of the calcium ingredient, or half of each, the slurry cannot carry all of both. Thus, either all of the salt or all of the calcium ingredient or a portion of each (e.g., 50:50 or 70:30) must be added as dry particulates in a third filling station. Useful herein for practicing this step are particulate metered feeding equipment that are commercially available such as are used for filling salt or sugar packets.

The present methods further essentially include a conventional finish step of sealing the open end of the microwave popcorn bag after the bag has been filled with the quantity of popcorn kernels, the fat slurry and the quantity of particulates.

### Product Use

The microwave popcorn products prepared as described can be used in a conventional manner for the at-home preparation of popcorn by microwave heating. Upon microwave heating of the sealed microwave popcorn article in a conventional home microwave oven, the resultant popped popcorn in the form of free flowing of individual substantially unagglomerated popped popcorn kernels exhibits excellent organoleptic attributes and with minimal scorching or browning.

It will thus be seen according to the description above, a highly advantageous trans fat replacement system for reducing or eliminating the presence of trans fats in popcorn food products has been provided.

While the invention has been described in connection with what is presently considered to be the most practical embodiments, it will be apparent to those of ordinary skill in the art that the invention is not to be limited to the disclosed embodiments, that many modifications and equivalent arrangements may be made thereof within the scope of the invention, which scope is to encompass all equivalent structures and products.

1. A composition comprising a saturated edible oil and an expanded low-density carbohydrate.

2. The composition of claim 1 wherein the expanded low-density carbohydrate has a moisture content of less than 8%.

3. The composition of claim 2 wherein the expanded low-density carbohydrate has a moisture content of about 7.6%.

4. The composition of claim 2 wherein the expanded low-density carbohydrate has a moisture content of less than 1%.

5. The composition of claim 1 wherein the expanded low-density carbohydrate has an oil entrainment capability of 4 to 10 times a weight of the low-density carbohydrate.

6. The composition of claim 5 wherein the oil entrainment capability is 5 to 6 times the weight of the low-density carbohydrate.

7. The composition of claim 5 wherein the oil entrainment capability is about 9 times the weight of the low-density carbohydrate.

8. The composition of claim 1 wherein the expanded low-density carbohydrate has a bulk density less than 0.5 g/cc.

9. The composition of claim 8 wherein the expanded low-density carbohydrate has a bulk density of 0.05 g/cc to 0.5 g/cc.

10. The composition of claim 9 wherein the expanded low-density carbohydrate has a bulk density of 0.05 g/cc to 0.4 g/cc.

11. The composition of claim 10 wherein the expanded low-density carbohydrate has a bulk density of 0.10 g/cc to 0.15 g/cc.

12. The composition of claim 1 wherein the expanded low-density carbohydrate is selected from the group consisting of expanded dextrins, starches, celluloses and gums.

13. The composition of claim 1 wherein the expanded low-density carbohydrate is maltodextrin.

14. The composition of claim 1 wherein the expanded low-density carbohydrate has a random porous structure.

15. The composition of claim 1 wherein the expanded low-density carbohydrate is ground popped popcorn.

16. The composition of claim 15 wherein the ground popped popcorn is 1-3% of the composition.

17. The composition of claim 1 further comprising a second saturated edible oil.

18. The composition of claim 1 further comprising further comprising an emulsifier.

19. The composition of claim 18 wherein the emulsifier comprises 1% of the composition.

20. The composition of claim 18 wherein the emulsifier is distilled monoglyceride.

21. A food product having a serving size and comprising the composition of claim 1 wherein an amount of trans fat in the food product is less than 0.5 grams per the serving size.

22. A microwave popcorn article comprising a microwave popcorn bag, and a food charge disposed therein comprising unpopped popcorn kernels and the composition of claim 1.

23. The microwave popcorn article of claim 22 further comprising a second saturated edible oil.
